(19) United States
(12) Patent Application Publication
(10) Pub. No.: US 2026/0064483 A1
(43) Pub. Date: Mar. 5, 2026

(54) ENTITLEMENT ENFORCEMENT FOR DATA PROCESSING SYSTEMS USING OUT-OF-BAND METHODS

(71) Applicant: Dell Products L.P., Round Rock, TX (US)

(72) Inventors: BASSEM EL-AZZAMI, Austin, TX (US); GOKUL THIRUCHENGODE VAJRAVEL, Bangalore (IN); ABEYE TESHOME, Austin, TX (US); RICHARD M. TONRY, Georgetown, TX (US); MOHIT ARORA, Frisco, TX (US); VINODKUMAR VASUDEV OTTAR, McKinney, TX (US); ADOLFO SANDOR MONTERO, Pflugerville, TX (US); LUIS ANTONIO VALENCIA REYES, Waxahachie, TX (US); RAJARAVI CHANDRA KOLLARAPU, Allen, TX (US)

(21) Appl. No.: 18/820,491

(22) Filed: Aug. 30, 2024

(51) Int. Cl. G06F 9/50; H04L 67/60

(52) U.S. Cl. CPC G06F 9/505; H04L 67/60

(57) ABSTRACT

Methods and systems for managing operation of a data processing system are disclosed. A management controller of the data processing system may obtain identifying information for a user of hardware resources of the data processing system. Based on the identifying information, entitlement data for the user may be obtained for use in performance of an entitlement enforcement process. Performance of the entitlement enforcement process may be initiated by the management controller and may include obtaining entitlement compliant hardware resources of the data processing system. A computer-implemented service for which the user is entitled to may be provided using the entitlement compliant hardware resources.

### FIELD

Embodiments disclosed herein relate generally to managing data processing systems. More particularly, embodiments disclosed herein relate to systems and methods to manage entitlement enforcement for the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a distributed system in accordance with an embodiment.

FIG. 1B shows a block diagram illustrating a data processing system in accordance with an embodiment.

FIG. 2 shows an interaction diagram in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may provide computer-implemented services to a user of the data processing system. To provide the computer-implemented services, the user may access functionality of hardware and/or software components of the data processing system in accordance with entitlement data for the user. For example, the entitlement data for the user may indicate functionality of the data processing system that the user is authorized to use. The entitlement data may include user entitlements (e.g., data access privileges for the user), software entitlements (e.g., software licenses registered to the user), and/or other types of entitlement data that may indicate which functionality of the data processing system the user is entitled to use.

When the hardware resources are operating nominally (e.g., in a desired state, as expected), then the hardware resources (e.g., a management entity hosted by the hardware resources) may enforce compliance with entitlements for the user on the data processing system. For example, the hardware resources may obtain and store entitlement data, and/or perform actions to manage (e.g., deactivate and/or activate) use of functionality of the data processing system based on the entitlement data.

However, when the hardware resources are operating abnormally (e.g., in a compromised state), then the hardware resources may lack capability to obtain reliable entitlement data and/or to manage the use of the functionality of the data processing system. As a result, the hardware resources may not operate in compliance with the entitlements for the user, which may (i) prevent provisioning of desired computer-implemented services to the user, and/or (ii) provide the user with computer-implemented services that the user is not authorized to use.

Thus, to improve a likelihood of operational compliance of the hardware resources with the entitlements for the user (e.g., during abnormal operation of the hardware resources), reliance on the hardware resources for entitlement enforcement may be reduced. To do so, the data processing system may include out-of-band components that may operate independently from in-band components (e.g., the hardware resources) of the data processing system.

For example, the out-of-band components may include a management controller with functionality for communicating with remote systems via secure out-of-band communication channels. The out-of-band communication channels may service the out-of-band components separately from the in-band components, which may be serviced by in-band communication channels. Therefore, the management controller may obtain reliable (e.g., up-to-date, trustworthy) entitlement data for users of the data processing system from a remote system in a secure manner and despite abnormal operation of the hardware resources.

The out-of-band components may manage operation of the in-band components. For example, the out-of-band components (e.g., the management controller) may manage entitlement enforcement for the data processing system. To do so, management controller may initiate performance of entitlement enforcement processes during which use of functionality of the hardware resources may be customized for a user based on (reliable) entitlement data for the user. By doing so, entitlement compliant hardware resources may be obtained using out-of-band methods. As a result, any computer-implemented services provided to the user using the hardware compliant hardware resources may be more likely to be desired computer-implemented services and computer-implemented services that the user is authorized to use.

In an embodiment, a method for managing operation of a data processing system is provided. The method may include: obtaining, by a management controller of the data processing system, identifying information for a user of hardware resources of the data processing system prior to the hardware resources providing computer-implemented services to the user; obtaining, by the management controller, entitlement data for the user based on the identifying information for the user; initiating, by the management controller and using the hardware resources, performance of an entitlement enforcement process based on the entitlement data to obtain entitlement compliant hardware resources of the data processing system; and, initiating, by the management controller, provisioning of a portion of the computer-implemented services using the entitlement compliant hardware resources, the user being entitled to use of the portion of the computer-implemented services.

The entitlement data may be obtained from a remote system by the management controller using an out-of-band communication channel. The entitlement data may indicate functionality of the data processing system that the user is authorized to use.

While the hardware resources are operating nominally, the hardware resources may be adapted to limit use of the computer-implemented services by the user to the portion of the computer-implemented services. While the hardware resources are operating abnormally, the hardware resources may lack capability to limit the use of the computer-implemented services by the user.

The performance of the entitlement enforcement process may include modifying, by at least the management controller, a data structure used by the hardware resources to prevent use of any of the computer-implemented services other than the portion of the computer-implemented services by the user.

The performance of the entitlement enforcement process may include, after the user ends a session with the hardware resources, modifying, by at least the management controller, a data structure used by the hardware resources to prevent use of any of the computer-implemented services by the user.

The data processing system may include a network module adapted to separately advertise network endpoints for the management controller and the hardware resources, the network endpoints being usable by a remote system to address communications to the hardware resources and the management controller.

An out-of-band communication channel that services the management controller may run through the network module, and an in-band communication channel that services the hardware resources may also run through the network module.

The management controller and the network module may be on separate power domains from the hardware resources so that the management controller and the network module are operable while the hardware resources are inoperable. The entitlement data may be obtained while the hardware resources are inoperable due to being unpowered.

A non-transitory media may include computer instructions that when executed by a processor cause the computer-implemented method to be performed.

The data processing system may include the non-transitory media and a processor, and may perform the computer-implemented method when the computer instructions are executed by the processor.

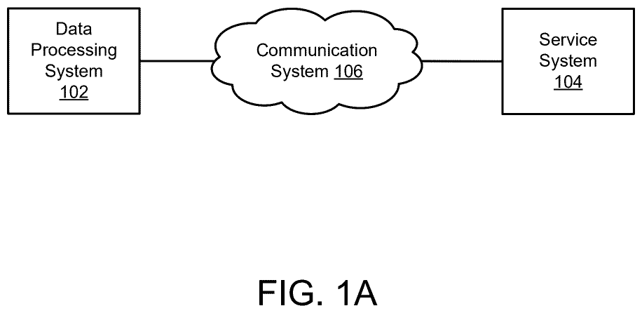

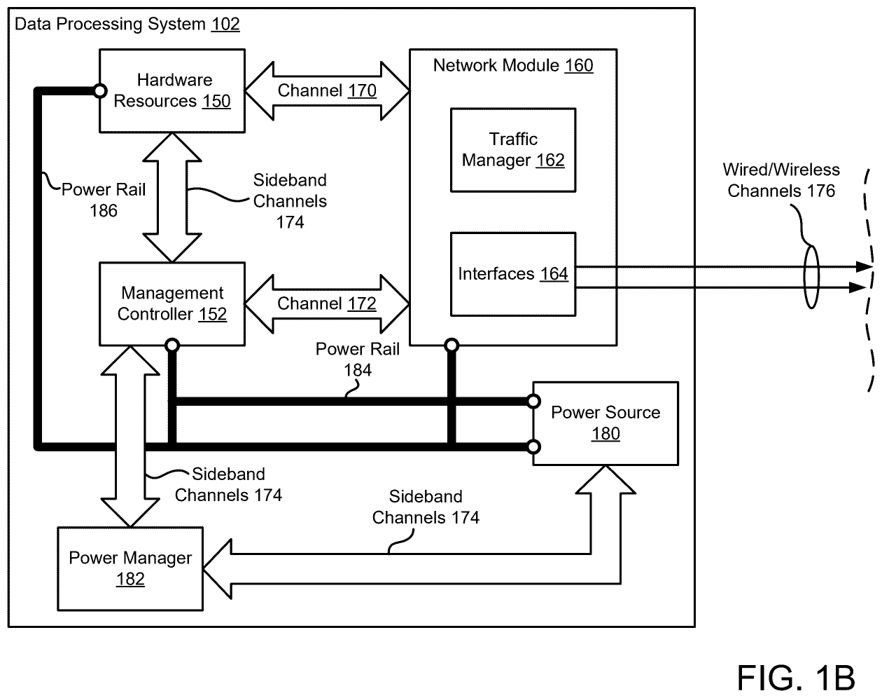

Turning to FIG. 1A, a block diagram illustrating a distributed system in accordance with an embodiment is shown. The system shown in FIG. 1A may provide computer-implemented services. The computer-implemented services may include any type and quantity of computer-implemented services. For example, the computer-implemented services may include communication services, data storage services, database services, data generation services, and/or any other type of service that may be implemented with a computing device.

To provide the computer-implemented services, the distributed system may include a data processing system (e.g., data processing system 102). The data processing system may include hardware and/or software components (e.g., hardware resources) and may provide computer-implemented services to a user. For example, the user may invoke and/or otherwise use functionality of the hardware and/or software components to obtain the computer-implemented services. However, the user may only be authorized to use a portion of the functionality of the data processing system, as indicated by entitlement data for the user.

The entitlement data may include information regarding software entitlements (e.g., software licensed to the user), user entitlements (e.g., levels of access and/or permissions of the user) and/or other types of information that may indicate functionality of the data processing system that the user is entitled to use. For example, the entitlement data may indicate entitlements for the user, such as applications hosted by the hardware resources that the user is authorized to use and/or data stored by the hardware resources that the user is authorized to access.

The entitlements for the user may differ from entitlements for other users and, over time, entitlements may be modified. For example, the entitlements may be modified as new applications (and/or data) are added or removed, and/or as the user requires increased access rights to applications (and/or data). The computer-implemented services may be provided to the user via access to applications and/or data; therefore, the entitlement data may indicate a portion of the computer-implemented services provided by the data processing system to which the user is entitled (e.g., authorized to use).

To provide the portion of the computer-implemented services to which the user is entitled, the hardware resources may operate in compliance with limits indicated by the entitlement data. For example, the user may not be entitled to use of all applications installed to (and/or data stored on) the data processing system. Therefore, the entitlement data for the user may indicate that some functionality of the hardware resources (e.g., some applications, some data access) should be disabled while the user is operating the data processing system in order to comply with the entitlements for the user (e.g., and related policies of the data processing system).

Enforcement of the entitlements on the data processing system may rely on nominal operation of the hardware resources. For example, to enforce compliance of the hardware resources with the entitlements for the user, the hardware resources may be required to (i) obtain reliable (e.g., authentic, up to date) entitlement data, and (ii) to perform actions to customize use of the computer-implemented services by the user as defined by the entitlement data.

For example, a user may initiate use of an application hosted by the hardware resources. In response, the hardware resources may identify and use entitlement data for the user in order to verify that the user is entitled (e.g., authorized) to use the application before continuing to launch the application (and/or otherwise allowing user access to the application).

However, when the hardware resources are operating abnormally (e.g., not nominally, such as when the hardware resources are in a compromised state), then the hardware resources may lack an ability to perform the required tasks for enforcement of the entitlements. For example, if the hardware resources are compromised, then the entitlement data obtained by and/or stored by the hardware resources may be undesirably modified (e.g., made inauthentic, so that entitlements for the user are removed and/or unlawfully added), and/or the hardware resources may lack an ability to allow use of the computer-implemented services by the user in accordance with authentic entitlement data. As a result, desired (e.g., expected) computer-implemented services may not be provided to the user.

In general, embodiments disclosed herein may provide methods, systems, and/or devices for managing operation of a data processing system in a manner that improves entitlement enforcement on hardware resources of a data processing system, even while the hardware resources are operating abnormally. To do so, the data processing system may include out-of-band components that operate independently from in-band components (e.g., the hardware resources) of the data processing system. The out-of-band components may include functionality for secure communication with a trusted remote system tasked with managing entitlement data for a user of the data processing system.

The out-of-band components may use out-of-band communication channels to obtain up-to-date entitlement data for the user from the trusted remote system, which may be more secure than using potentially compromised in-band communication channels that service the hardware resources. The out-of-band components may also include functionality for modifying data structures used by the hardware resources when providing the computer-implemented services, thereby modifying operation of the hardware resources to obtain entitlement compliant hardware resources. The entitlement compliant hardware resources may be used to provide the desired computer-implemented services to the user (e.g., in accordance with limits on use of functionality of the hardware resources indicated by the entitlement data).

By doing so, the entitlement data may be more likely to be reliable (e.g., up-to-date, authentic), and entitlement compliant hardware resources may be more likely to be obtained than when relying on in-band methods (e.g., using hardware resources and in-band communication channels).

To provide the above-mentioned functionality, the distributed system of FIG. 1A may include data processing system 102, service system 104, and communication system 106. The distributed system, any components thereof, and/or any other types of devices or components not shown in FIG. 1A may perform all, or a portion of the computer-implemented services independently and/or cooperatively. Each of these components is discussed below.

Data processing system 102 may include any number of data processing systems. Data processing system 102 may be operated directly or indirectly (e.g., via other devices) by any number of users. Data processing system 102 may provide computer-implemented services to its user(s). For example, a user may operate data processing system 102 to obtain a portion of the computer-implemented services to which the user is entitled, as indicated by entitlement data for the user.

To provide the computer-implemented services, data processing system 102 may include in-band components such as hardware resources (e.g., hardware and/or software components). The entitlement data may indicate whether the user has authority (e.g., permission and/or licenses) to use portions of the hardware and/or the software components.

To manage entitlement enforcement on the hardware resources, data processing system 102 may include out-of-band components, such as a management controller. The management controller may include functionality for exchanging data with other devices (e.g., remote systems) via out-of-band communication channels. The management controller may operate independently from the hardware resources and may include functionality for managing (e.g., modifying) operation of the hardware resources to enforce entitlements for the user. Refer to the discussion of FIG. 1B for more information regarding components of data processing system 102.

For example, when managing entitlement enforcement, the management controller may (i) obtain identifying information for a user of hardware resources of data processing system 102, (ii) obtain and/or store entitlement data for the user (e.g., based on the identifying information for the user), (iii) initiate performance of entitlement enforcement processes to obtain entitlement compliant hardware resources (e.g., hardware resources that operate in a manner that allows user access to functionality of the hardware resources that the user is authorized to use and prevents user access to functionality of the hardware resources that the user is not authorized to use, as indicated by the entitlement data), (iv) initiate provisioning of computer-implemented services (e.g., using the entitlement compliant hardware resources, which may limit use of the computer-implemented services to use of a portion of the computer-implemented services by the user), and/or (v) initiate other actions (e.g., for managing the entitlement data and/or operation of the hardware resources).

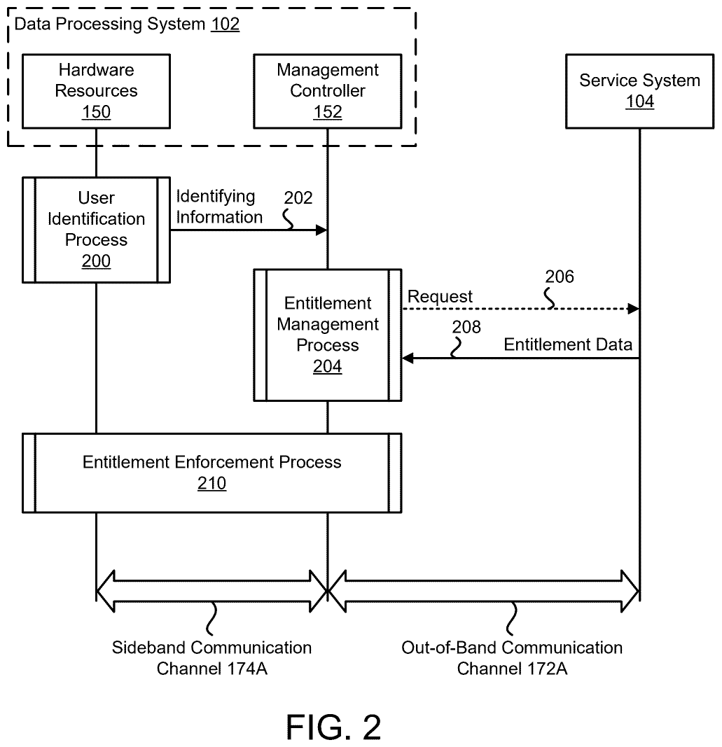

For example, the management controller may use an out-of-band communication channel to obtain entitlement data from a remote system, such as service system 104. By doing so, the entitlement data may be obtained in a manner that circumvents potentially compromised in-band communication channels that service the hardware resources. When initiating actions for entitlement enforcement, the management controller may do so without participation from potentially compromised hardware resources, thereby increasing a likelihood that entitlements for the user are appropriately enforced. Refer to the discussion of FIG. 2 for more information regarding entitlement enforcement.

Service system 104 may include any number of systems that provide computer-implemented (e.g., Cloud) services for data processing system 102. For example, service system 104 may include a system trusted by data processing system 102 to provide entitlement data management services for data processing system 102. To perform the services, service system 104 may communicate and/or exchange data with components of data processing system 102 (e.g., the management controller via out-of-band communication channels and/or the hardware resources via in-band communication channels).

For example, service system 104 may (i) obtain (new and/or updated) entitlement data for a user of data processing system 102 (e.g., from the hardware resources, from the management controller, and/or from other devices), (ii) store (backups of) the entitlement data, (iii) obtain requests for entitlement data, (iv) respond to the requests for entitlement data (e.g., by providing copies of the requested entitlement data to requesting devices), and/or (v) perform other actions for managing the entitlement data (e.g., synchronizing up-to-date entitlement data with the management controller and/or other devices in accordance with data synchronization policies).

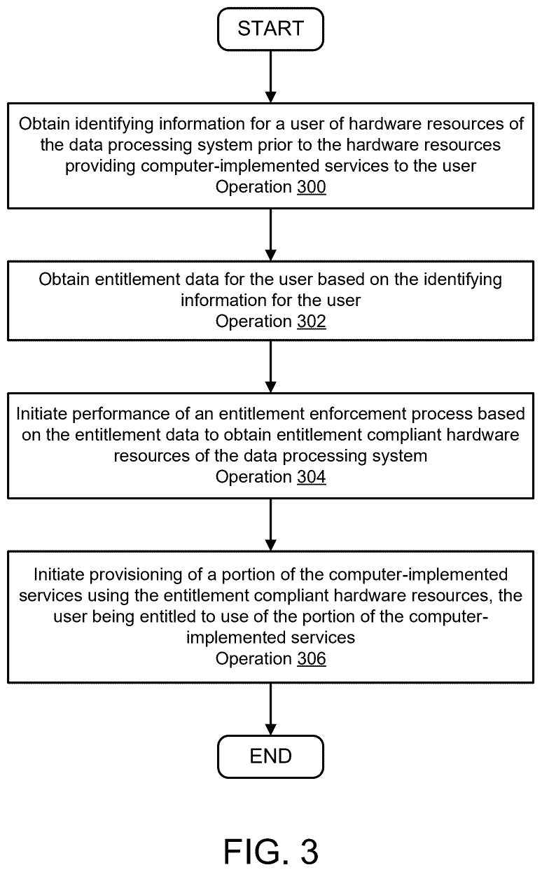

When providing their functionality, any of data processing system 102, service system 104, and/or components thereof may perform all, or a portion of the actions and methods illustrated in FIGS. 2-3.

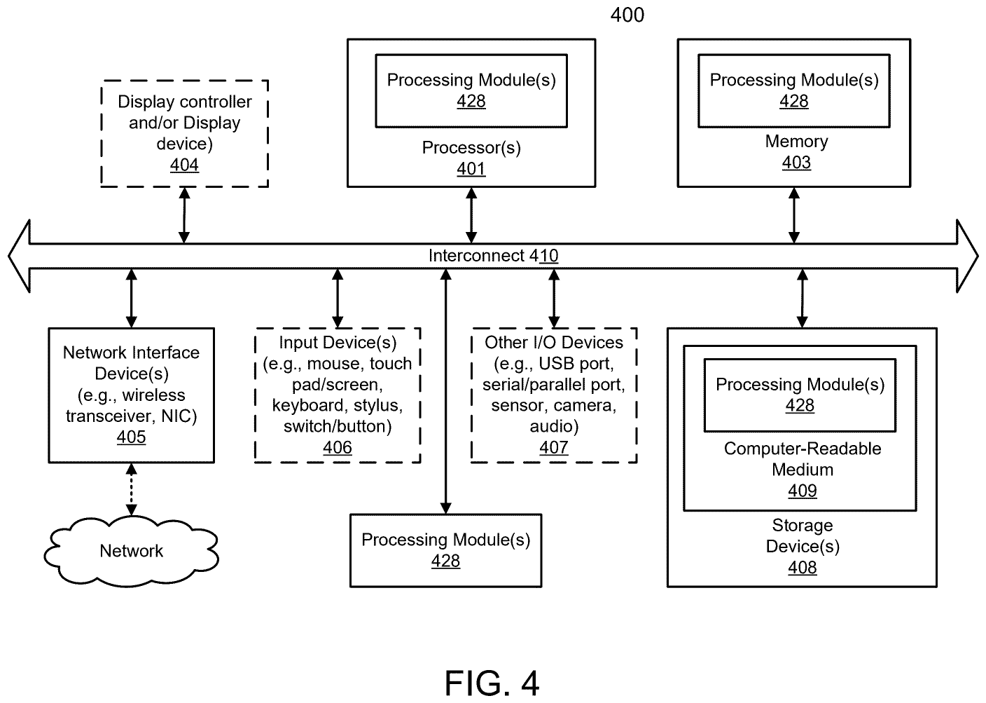

Any of data processing system 102 and service system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1A may be operably connected to each other (and/or components not illustrated) with communication system 106. Communication system 106 may facilitate communications between the components of FIG. 1A. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1A as including a limited number of specific components, a system in accordance with an embodiment may include fewer, additional, and/or different components than those illustrated therein.

Turning to FIG. 1B, a diagram illustrating a data processing system in accordance with an embodiment is shown. Data processing system 102 shown in FIG. 1B may be similar to any of the computing devices shown in FIG. 1A.

To provide computer-implemented services, data processing system 102 may include any quantity of hardware resources 150. Hardware resources 150 may be in-band (hardware) components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, then these entities may subsequently compromise the operation of the applications. For example, if various drivers and/or the communication stack are compromised, then communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 102) to another device via any number of intermediate networks (e.g., via wired/wireless channels 176 that are part of the networks).

To reduce the likelihood of the applications and/or other in-band entities from being indirectly compromised, data processing system 102 may include management controller 152 and network module 160. Each of these components of data processing system 102 is discussed below.

Management controller 152 may be implemented, for example, using a system on a chip or other type of independently operating computing device (e.g., independent from the in-band components, such as hardware resources 150 of a host data processing system 102). Management controller 152 may provide various management functionalities for data processing system 102. Management controller 152 may, for example, monitor various ongoing processes performed by the in-band components, may manage power distribution, thermal management, and/or may perform other functions for managing data processing system 102. For example, management controller 152 may monitor activity of hardware resources 150 in order to obtain identifying information for a user of data processing system 102 (refer to FIG. 2).

To do so, management controller 152 may be operably connected to various components via sideband channels 174 (in FIG. 1B, a limited number of sideband channels are included for illustrative purposes, it will be appreciated that management controller 152 may communicate with other components via any number of sideband channels such as sideband communication channel 174A shown in FIG. 2). The sideband channels may be implemented using separate physical channels, and/or with a logical channel overlay over existing physical channels (e.g., logical division of in-band channels).

The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, when managing entitlement enforcement for data processing system 102, management controller 152 may use sideband channels 174 to modify data structures used by hardware resources 150 in order to prevent use (by the user) of portions of computer-implemented services provided by data processing system 102 to which the user is not entitled.

To reduce the likelihood of indirect compromise of an application hosted by hardware resources 150, management controller 152 may, for example, enable information from other devices to be provided to the application without traversing the network stack and/or management entities of hardware resources 150. To do so, the other devices may direct communications including the information to management controller 152.

Management controller 152 may then, for example, send the information via sideband channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similarly, processes may be used to facilitate outbound communications from the applications.

Management controller 152 may be operably connected to communication components of data processing system 102 via separate channels (e.g., 172, 172A shown in FIG. 2) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted components may not result in indirect compromise of any management controller 152, and entities hosted by management controller 152.

To facilitate communication with other devices, data processing system 102 may include network module 160. Network module 160 may provide communication services for in-band components and out-of-band components (e.g., management controller 152) of data processing system 102. To do so, network module 160 may include traffic manager 162, and interfaces 164.

Traffic manager 162 may include functionality to (i) discriminate traffic directed to various network endpoints advertised by data processing system 102, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

For example, when communicating with a remote system (e.g., service system 104), messages from the remote system may be addressed to a network endpoint advertised by network module 160 for out-of-band communications. The messages may include, for example, entitlement data for a user of data processing system 102 and/or other information. When messages are received by traffic manager 162, traffic manager 162 may forward the message to management controller 152 via an out-of-band communication channel (e.g., channel 172), differentiating the message from in-band communications to data processing system 102.

By doing so, data processing system 102 may be more likely to obtain the entitlement data securely even when hardware resources 150 are compromised and/or inoperable. Similarly, messages sent from management controller 152 (e.g., including requests for entitlement data) to the remote system may be transmitted via the out-of-band communication channel to network module 160, bypassing the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wireless wide area network (WWAN) card, a Wi-Fi card, a wireless local area network card, a wired local area network card, an optical communication card, and/or other types of communication components. These components may support any number of wired/wireless channels 176.

Thus, from the perspective of an external device, the in-band components and out-of-band components of data processing system 102 may appear to be two independent network entities that may be independently addressable and/or otherwise unrelated to one another.

To facilitate management of data processing system 102 over time, hardware resources 150, management controller 152 and/or network module 160 may be positioned in separately controllable power domains. By being positioned in these separate power domains, different subsets of these components may remain powered while other subsets are unpowered.

For example, management controller 152 and network module 160 may remain powered while hardware resources 150 is unpowered. Consequently, management controller 152 may remain able to communicate with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

Therefore, even when hardware resources 150 are operating abnormally (e.g., in a compromised state, in an unpowered state), the out-of-band components may remain powered in order to perform actions relating to entitlement enforcement for data processing system 102. For example, while hardware resources 150 are unpowered, power distribution may be managed so that management controller 152 may still request and/or obtain entitlement data for users of data processing system 102 from remote systems.

By doing so, when the entitlement data for the users is updated (e.g., with service system 104), up-to-date entitlement data may be provided to management controller 152 in real-time, increasing a likelihood that management controller 152 will have access to up-to-date entitlement data for a user when operated by the user.

To implement the separate power domains, data processing system 102 may include a power source (e.g., 180) that separately supplies power to power rails (e.g., power rail 184, power rail 186) that power the respective power domains. Power from the power source (e.g., a power supply, battery, etc.) may be selectively provided to the separate power rails to selectively power the different power domains. A power manager (e.g., 182) may manage power from power source 180, supplied via the power rails (e.g., by providing instructions via sideband channels 174). Management controller 152 may cooperate with power manager 182 to manage supply of power to these power domains. Management controller 152 may communicate with power manager 182 via sideband channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

To further clarify embodiments disclosed herein, an interaction diagram in accordance with an embodiment is shown in FIG. 2. The interaction diagram may illustrate how data may be obtained and used within the system of FIGS. 1A-1B.

In the interaction diagrams, processes performed by and interactions between components of a (distributed) system in accordance with an embodiment are shown. In the diagrams, components of the system are illustrated using a first set of shapes (e.g., 150, 152, etc.), located towards the top of each figure. Lines descend from these shapes. Processes performed by the components of the system are illustrated using a second set of shapes (e.g., 200, 204) superimposed over these lines.

Interactions (e.g., communication, data transmissions, etc.) between the components of the system are illustrated using a third set of shapes (e.g., 202, 206) that extend between the lines. The third set of shapes may include lines terminating in arrows that may indicate one-way interactions (e.g., data transmission from a first component to a second component). Some of the third set of shapes may be drawn in dashing to indicate that corresponding interactions are optional and/or may not occur (e.g., 206).

Thick arrows (e.g., sideband communication channel 174A, out-of-band communication channel 172A) may indicate communication channels over which multi-way interactions are facilitated (e.g., data transmission between two components).

Generally, the processes and interactions are temporally ordered in an example order, with time increasing from the top to the bottom of each page. For example, the interaction labeled as 202 may occur prior to the interaction labeled as 208. However, it will be appreciated that the processes and interactions may be performed in different orders, any may be omitted, and other processes or interactions may be performed without departing from embodiments disclosed herein.

Turning to FIG. 2, an interaction diagram in accordance with an embodiment is shown. The interaction diagram may illustrate processes and interactions that may occur when managing entitlement enforcement for a data processing system.

The data processing system (e.g., data processing system 102) may be operated by a user and may include hardware resources 150, management controller 152, and/or other components (not shown). The user may initiate a session with hardware resources 150 (e.g., by logging in to an application and/or an operating system of data processing system 102). The session may include a period of time during which the user is operating data processing system 102 (e.g., from log in to log off).

To manage entitlement enforcement for the data processing system, the user of the data processing system may be identified. To identify the user, hardware resources 150 may perform user identification process 200. During user identification process 200, identifying information for the user may be obtained, for example, based on an interaction with the user. For example, the user may participate in a process using hardware resources 150 where user input is provided to a portion of hardware resources 150.

The user input may be obtained, for example, when the user interacts with an operating system hosted by hardware resources 150 (e.g., during a log in process), applications hosted by hardware resources 150 such as a captive portal, and/or during any process (e.g., hosted by hardware resources 150) where an identity of the user is alleged. For example, the user may use a security token to authenticate during login, and/or access tokens may be generated during a login process and/or the access tokens may be inherited by subsequent processes initiated by the user and/or the login process.

During user identification process 200, hardware resources 150 may generate the identifying information for the user by packaging information obtained based on the user input, from generated tokens, and/or using other information. For example, the identifying information for the user may include a user identifier, group identifiers and/or other information.

At interaction 202, hardware resources 150 may provide the identifying information (for the user) to management controller 152 over sideband communication channel 174A via (i) transmission via a message, (ii) storing in a storage with subsequent retrieval by management controller 152, (iii) a publish-subscribe system where management controller 152 subscribes to updates from hardware resources 150 thereby causing a copy of the identifying information to be propagated to management controller 152, and/or (iv) other processes.

Management controller 152 may monitor activity of hardware resources 150 (e.g., management controller 152 may snoop processes of hardware resources 150 using sideband communication channel 174A) and may identify that a process that may trigger hardware resources 150 to obtain and/or generate the identifying information for the user has been initiated or performed. Therefore, at interaction 202, management controller 152 may automatically fetch the identifying information for the user from hardware resources 150 (e.g., from a storage component of hardware resources 150).

When hardware resources 150 are operating nominally, entitlement data for the user stored in a storage component of hardware resources 150 may be identified (e.g., by hardware resources 150), and used to manage (e.g., limit or allow) user access to functionality of hardware resources 150. However, if hardware resources 150 are compromised (e.g., under control of a malicious party) and/or otherwise operating abnormally, then the entitlement data may not be reliable (e.g., trustworthy) for managing user access to the functionality of hardware resources 150.

For example, a malicious party may gain access to hardware resources 150 and may locate the entitlement data stored by hardware resources 150. The malicious party may then modify (e.g., replace, corrupt) the entitlement data to unlawfully add entitlements (e.g., by introducing fraudulent software licenses and/or certificates to the entitlement data) and/or undesirably remove entitlements for the user (e.g., by corrupting a certificate indicating user entitlements). However, due to operational partitioning of hardware resources 150 and management controller 152, the malicious party may not be able to access storage of and/or control operation of management controller 152.

Therefore, upon obtaining the identifying information for the user, management controller 152 may perform actions to obtain reliable entitlement data for the user during performing entitlement management process 204. For example, management controller 152 may store entitlement data for various users of data processing system 102 locally (e.g., accessible only by management controller 152). During entitlement management process 204, the identifying information for the user may be used to identify entitlement data from local storage of management controller 152 and/or to request entitlement data from service system 104.

For example, if management controller 152 identifies that a copy of the entitlement data for the user in local storage is stale (e.g., expired, as defined by policies of data processing system 102), then management controller 152 may request up-to-date entitlement data from service system 104. During entitlement management process 204, management controller 152 may obtain (e.g., generate) a request for entitlement data for the user. The request may include, for example, the identifying information for the user and/or other information (e.g., cryptographically verifiable information, device identifiers).

At interaction 206, management controller 152 may provide the request to service system 104 over out-of-band communication channel 172A via (i) transmission via a message, (ii) storing in a storage with subsequent retrieval by service system 104, (iii) a publish-subscribe system where service system 104 subscribes to updates from management controller 152 thereby causing a copy of the request to be propagated to service system 104, and/or (iv) other processes. By providing the request to service system 104, service system 104 may perform entitlement data management services for data processing system 102.

An arrow indicating occurrence of interaction 206 is drawn in dashing to indicate that providing the request for the entitlement data for the user is optional and/or may not occur during entitlement management process 204. For example, service system 104 may automatically provide (e.g., push) entitlement data for users of data processing system 102 to management controller 152 (e.g., via out-of-band communication channel 172A) based on a data synchronization schedule and/or when entitlement data is updated (e.g., by an administrator).

To provide entitlement data management services for data processing system 102, service system 104 may identify adequate (e.g., up to date) entitlement data for the user (e.g., based on information included in a request and/or based on other information if a request is not provided to service system 104). For example, service system 104 may use the information included in a request for entitlement data (e.g., user identifiers, device identifiers) to query a database of entitlement data for various users of various data processing systems.

The entitlement data for the user may include, for example, (i) a list of applications licensed to user (and/or license status information), (ii) a list of user privileges and/or permission levels for the user, and/or (iii) other data that may be usable to (cryptographically) verify that authority to use various functionality of hardware resources 150 has been granted to the user by an entity authorized to grant the authority (e.g., certificates).

At interaction 208, service system 104 may provide the entitlement data (for the user) to management controller 152 over out-of-band communication channel 172A via (i) transmission via a message, (ii) storing in a storage with subsequent retrieval by management controller 152, (iii) a publish-subscribe system where management controller 152 subscribes to updates from service system 104 thereby causing a copy of the entitlement data to be propagated to management controller 152, and/or (iv) other processes.

Management controller 152 may perform some portions of entitlement management process 204 while hardware resources 150 are operating abnormally. For example, if hardware resources 150 are compromised by a malicious party, then the malicious party may attempt to deactivate network communications between data processing system 102 and service system 104 in order to prevent updates to entitlement data stored in hardware resources 150. For example, the malicious party may depower in-band network devices and/or portions of hardware resources 150 and/or by deactivate network functionality of hardware resources 150.

To circumvent compromised hardware resources 150, management controller 152 may manage power distribution to some components of hardware resources 150 (e.g., a network module) in order to facilitate providing the request to and/or obtaining the entitlement data from service system 104. Thus, during entitlement management process 204, the requesting and/or the obtaining of the entitlement data may be performed surreptitiously from hardware resources 150, and therefore activity of the management controller 152 may be unbeknownst to the malicious party.

To enforce entitlements for the user on hardware resources 150, management controller 152 may initiate performance of entitlement enforcement process 210 to obtain entitlement compliant hardware resources. Entitlement compliant hardware resources may include hardware resources 150 when hardware resources 150 are operating in accordance with entitlement data for the user. For example, entitlement compliant hardware resources may only provide computer-implemented services to which the user is entitled.

During entitlement enforcement process 210, access to use of functionality of hardware resources 150 (e.g., access to applications, data access) may be managed based on the entitlement data for the user. For example, management controller 152 may identify functionality of hardware resources 150 that should be activated and/or deactivated for the user based on the entitlement data for the user. User access to functionality of hardware resources 150 may be managed in real-time (e.g., when a user invokes use of a function of hardware resources 150) and/or prior to the user invoking use of a function of hardware resources 150.

For example, an agent running on hardware resources 150 on behalf of management controller 152 may identify that the user has invoked use of a function of hardware resources 150, such as an application. During entitlement enforcement process 210, management controller 152 may issue cryptographically verifiable data structures (e.g., instructions, certificates, licenses) to the agent based on the entitlement data for the user. The agent may verify whether the user is authorized to use the application based on the entitlement data for the user and/or information received from management controller 152.

For example, use of the application may require a license, and the entitlement data may indicate that the user is licensed to use the application; therefore, the agent may allow hardware resources 150 (e.g., an operating system hosted by hardware resources 150) to continue to launch the application. However, if the entitlement data indicates that the user is not licensed to use the application, then the agent may prevent hardware resources 150 from launching the application.

During entitlement enforcement process 210, data structures used by hardware resources 150 when providing computer-implemented services to the user may be modified. The data structures may be modified in a manner that prevents use of any computer-implemented services by the user other than a portion of the computer-implemented services to which the user is entitled. For example, data structures may be encrypted, or hidden (e.g., by encrypting application metadata) to deactivate functionality of hardware resources 150, data structures may be decrypted to activate functionality of hardware resources 150, and/or other actions may be performed to obtain entitlement compliant hardware resources.

Entitlement enforcement process 210 may run as a background process during the session. After the user ends the session with hardware resources 150 (e.g., after the user closes an application and/or logs out of the operating system), data structures used by hardware resources 150 when providing computer-implemented services to the user may be modified in a manner that prevents use of any of the computer-implemented services by the user. For example, management controller 152 may (i) encrypt data structures, (ii) issue a cryptographically verifiable data structure to an agent hosted by hardware resources 150 that indicates expiry of previously issued instructions, licenses, certificates, etc., and/or (iii) otherwise limit access to functionality of hardware resources 150. Doing so may place data processing system 102 in a state for proactive entitlement enforcement.

Entitlement enforcement process 210 may be performed independently and/or cooperatively by management controller 152 and/or hardware resources 150. For example, portions of entitlement enforcement process 210 may be performed by an agent of management controller 152 hosted by hardware resources 150, by an operating system or other applications hosted by hardware resources 150 (e.g., using instructions provided by management controller 152 over sideband communication channel 174A), and/or by management controller 152 via sideband communication channel 174A.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using processes and interactions shown in FIG. 2, entitlement data for a user of a data processing system may be obtained and used to obtain entitlement compliant hardware resources using out-of-band methods. By doing so, when the hardware resources are operating abnormally, the entitlement data may be more likely to be reliable, and entitlements for the user may be more likely to be enforced on the hardware resources than when using in-band methods.

Turning to FIG. 3, a flow diagram illustrating a method in accordance with an embodiment is shown. The flow diagram may illustrate various operations performed when managing operation of a data processing system in view of entitlement enforcement.

At operation 300, identifying information for a user of hardware resources of the data processing system may be obtained. The identifying information may be obtained by (i) receiving the identifying information (e.g., from another device), (ii) reading the identifying information (e.g., from storage), (iii) generating the identifying information, and/or (iv) by other methods (e.g., by using methods described with respect to user identification process 200 and/or interaction 202 of FIG. 2B).

For example, a management controller of the data processing system may obtain the identifying information via a sideband channel (e.g., from the hardware resources) when the identifying information is generated by a process performed by the hardware resources (e.g., user identification process 200 of FIG. 2). The identifying information may be obtained (e.g., by the management controller) prior to the hardware resources providing computer-implemented services to the user.

At operation 302, entitlement data for the user may be obtained based on the identifying information for the user. The entitlement data may be obtained by (i) receiving the entitlement data (e.g., from another device, such as a remote system), (ii) reading the entitlement data (e.g., from storage, such as local storage of the management controller), (iii) generating the entitlement data, and/or (iv) by other methods (e.g., by using methods described with respect to interactions 206-208 of FIG. 2B). For example, the entitlement data may be obtained by the management controller from a remote system using an out-of-band communication channel, independently from the hardware resources and in-band communication channels.

The entitlement data may be obtained (e.g., by the management controller and from the remote system) while the hardware resources are inoperable (e.g., unpowered) and/or otherwise operating abnormally. To do so, for example, the management controller may manage power distribution to portions of the hardware resources (e.g., a network card of the data processing system) in order to facilitate requesting and/or obtaining of the entitlement data from the remote system.

The entitlement data may indicate functionality of the data processing system that the user is authorized to use. Therefore, the entitlement data may be used to customize operation (e.g., functionality) of the hardware resources in accordance with entitlements (e.g., licenses, access permissions) for the user. For example, while the hardware resources are operating nominally, the hardware resources may be adapted to limit the computer-implemented services by the user to a portion of the computer-implemented services that the entitlement data indicates that the user is authorized to use.

However, while the hardware resources are operating abnormally (e.g., not nominally, in a compromised state, in an inoperable state), the hardware resources may lack capability to limit the use of the computer-implemented services by the user. Therefore, enforcement of the entitlements for the user may be performed using out-of-band methods that do not rely on nominal operation of the hardware resources.

At operation 304, performance of an entitlement enforcement process may be initiated based on the entitlement data to obtain entitlement compliant hardware resources of the data processing system. The performance of the entitlement enforcement process may be initiated by (i) identifying functionality of the hardware resources to which the user is entitled based on the entitlement data, (ii) obtaining instructions for activating and/or deactivating portions of functionality of the hardware resources in accordance with the identified functionality, and/or (ii) providing and/or executing a portion (e.g., some, all) of the instructions. The management controller may initiate performance of the entitlement enforcement process.

For example, the management controller may generate the instructions based on the entitlement data, execute a first portion of the instructions, and/or provide a second portion of the instructions to the hardware resources for execution.

Performing the entitlement enforcement process may include modifying, by at least the management controller, a data structure used by the hardware resources to prevent use of any of the computer-implemented services other than the portion of the computer-implemented services by the user. For example, the data structure may be modified by (i) obtaining instructions for encrypting or decrypting data structures (e.g., and/or metadata thereof), and/or (ii) executing, by the management controller and/or the hardware resources, portions of the instructions. Executing the instructions may modify the data structures so that functionality of the hardware resources is updated (e.g., increased, decreased, maintained) in accordance with entitlement data. Once operation (e.g., functionality) of the hardware resources is updated, the hardware resources may include entitlement compliant hardware resources.

Performing the entitlement enforcement process may include (e.g., after the user ends a session with the hardware resources), modifying, by at least the management controller, a data structure used by the hardware resources to prevent use of any of the computer-implemented services by the user. For example, the data structure may be modified by (i) obtaining instructions for encrypting data, removing data access permissions, and/or other instructions for reducing functionality of the hardware resources, and/or (ii) executing (e.g., by the management controller and/or the hardware resources, cooperatively and/or independently) the instructions.

By doing so, the data processing system may be placed in a state that proactively enforces entitlements for various users of data processing system. Refer to the discussion of entitlement enforcement process 210 of FIG. 2 for more information regarding the entitlement enforcement process.

At operation 306, provisioning of a portion of the computer-implemented services (e.g., to which the user is entitled to use) using the entitlement compliant hardware resources may be initiated. The provisioning of the portion of the computer-implemented services may be initiated by (i) obtaining instructions for initiating the portion of the computer-implemented services (e.g., obtaining user input via an interface hosted by the entitlement compliant hardware resources), and/or (ii) adding (e.g., inserting, appending) the instructions to an execution flow for the entitlement compliant hardware resources.

For example, the instructions may include instructions for launching an application hosted by the entitlement compliant hardware resources that the user is authorized to use, and the entitlement compliant hardware resources may execute the instructions, causing the application to launch successfully in order to provide the portion of the computer-implemented services.

The method may end following operation 306.

Thus, as illustrated above, embodiments disclosed herein may provide systems and methods for managing operation of a data processing system in a manner that increases a likelihood of compliance with entitlements for the user. By using out-of-band methods to manage entitlement data and/or entitlement enforcement on hardware resources of the data processing system, reliance on potentially compromised and/or inoperable hardware resources of the data processing system may be reduced.

Any of the components illustrated in FIGS. 1A-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
obtaining, by a management controller of the data processing system, identifying information for a user of hardware resources of the data processing system prior to the hardware resources providing computer-implemented services to the user;
obtaining, by the management controller, entitlement data for the user based on the identifying information for the user;
initiating, by the management controller and using the hardware resources, performance of an entitlement enforcement process based on the entitlement data to obtain entitlement compliant hardware resources of the data processing system; and
initiating, by the management controller, provisioning of a portion of the computer-implemented services using the entitlement compliant hardware resources, the user being entitled to use of the portion of the computer-implemented services.

2. The method of claim 1, wherein the entitlement data is obtained from a remote system by the management controller using an out-of-band communication channel.

3. The method of claim 2, wherein the entitlement data indicates functionality of the data processing system that the user is authorized to use.

4. The method of claim 3, wherein, while the hardware resources are operating nominally, the hardware resources are adapted to limit use of the computer-implemented services by the user to the portion of the computer-implemented services.

5. The method of claim 4, wherein, while the hardware resources are operating abnormally, the hardware resources lack capability to limit the use of the computer-implemented services by the user.

6. The method of claim 1, wherein the performance of the entitlement enforcement process comprises:
modifying, by at least the management controller, a data structure used by the hardware resources to prevent use of any of the computer-implemented services other than the portion of the computer-implemented services by the user.

7. The method of claim 1, wherein the performance of the entitlement enforcement process comprises:
after the user ends a session with the hardware resources:
modifying, by at least the management controller, a data structure used by the hardware resources to prevent use of any of the computer-implemented services by the user.

8. The method of claim 1, wherein the data processing system comprises a network module adapted to separately advertise network endpoints for the management controller and the hardware resources, the network endpoints being usable by a remote system to address communications to the hardware resources and the management controller.

9. The method of claim 8, wherein an out-of-band communication channel that services the management controller runs through the network module, and an in-band communication channel that services the hardware resources also runs through the network module.

10. The method of claim 8, wherein the management controller and the network module are on separate power domains from the hardware resources so that the management controller and the network module are operable while the hardware resources are inoperable.

11. The method of claim 10, wherein the entitlement data is obtained while the hardware resources are inoperable due to being unpowered.

12. A non-transitory machine-readable medium having instructions stored therein, which when executed by a processor, cause the processor to perform operations for managing operation of a data processing system, the operations comprising:
obtaining, by a management controller of the data processing system, identifying information for a user of hardware resources of the data processing system prior to the hardware resources providing computer-implemented services to the user;
obtaining, by the management controller, entitlement data for the user based on the identifying information for the user;
initiating, by the management controller and using the hardware resources, performance of an entitlement enforcement process based on the entitlement data to obtain entitlement compliant hardware resources of the data processing system; and
initiating, by the management controller, provisioning of a portion of the computer-implemented services using the entitlement compliant hardware resources, the user being entitled to use of the portion of the computer-implemented services.

13. The non-transitory machine-readable medium of claim 12, wherein the entitlement data is obtained from a remote system by the management controller using an out-of-band communication channel.

14. The non-transitory machine-readable medium of claim 13, wherein the entitlement data indicates functionality of the data processing system that the user is authorized to use.

15. The non-transitory machine-readable medium of claim 14, wherein, while the hardware resources are operating nominally, the hardware resources are adapted to limit use of the computer-implemented services by the user to the portion of the computer-implemented services.

16. The non-transitory machine-readable medium of claim 15, wherein, while the hardware resources are operating abnormally, the hardware resources lack capability to limit the use of the computer-implemented services by the user.

17. A data processing system, comprising:
a processor; and
a memory coupled to the processor to store instructions, which when executed by the processor, cause operations to be performed, the operations comprising:
obtaining, by a management controller of the data processing system, identifying information for a user of hardware resources of the data processing system prior to the hardware resources providing computer-implemented services to the user;
obtaining, by the management controller, entitlement data for the user based on the identifying information for the user;
initiating, by the management controller and using the hardware resources, performance of an entitlement enforcement process based on the entitlement data to obtain entitlement compliant hardware resources of the data processing system; and
initiating, by the management controller, provisioning of a portion of the computer-implemented services using the entitlement compliant hardware resources, the user being entitled to use of the portion of the computer-implemented services.

18. The data processing system of claim 17, wherein the entitlement data is obtained from a remote system by the management controller using an out-of-band communication channel.

19. The data processing system of claim 18, wherein the entitlement data indicates functionality of the data processing system that the user is authorized to use.

20. The data processing system of claim 19, wherein, while the hardware resources are operating nominally, the hardware resources are adapted to limit use of the computer-implemented services by the user to the portion of the computer-implemented services.
